(19) United States
(12) Patent Application Publication
(10) Pub. No.: US 2020/0012245 A1
(43) Pub. Date: Jan. 9, 2020

(54) Home automation device for package delivery and receipt

(71) Applicant: Angeles Marin Pulido, Madrid (ES)

(72) Inventor: Angeles Marin Pulido, Madrid (ES)

(21) Appl. No.: 16/028,456

(22) Filed: Jul. 6, 2018

(51) Int. Cl. G05B 19/042; G06Q 50/28; G06K 7/14

(52) U.S. Cl. CPC G05B 19/042; G05B 2219/2642; G06K 7/1417; G06Q 50/28

(57) ABSTRACT

Home automation device for package delivery and receipt comprising at least one smart locker with one or several receptacles, each one provided with a door with a lock with automatic opening controlled through an electronic board linked to a touch screen on each locker, which is installed within the building, entrance hall or location on the property of the home of one or more users of the service, or else in a separate location; and a home automation video-entry phone installed externally to said building or location, next to the entrance connected to its lock, equipped with at least one video camera, a touch screen, a QR code reader, an internet connection module and a programmable operating system with specific software to give access to this entrance using the QR code that the reader detects, in order to be linked to a mobile phone application.

### CROSS-REFERENCE TO RELATED APPLICATIONS

Not applicable

### STATEMENT REGARDING FEDERALLY SPONSORED RESEARCH OR DEVELOPMENT

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT INCORPORATION-BY-REFERENCE OF MATERIAL SUBMITTED ON A COMPACT DISC

Not applicable

### BACKGROUND OF THE INVENTION TECHNICAL FIELD

### Field the Invention

The field of application of this invention is framed in the area of package delivery, specifically within the sector of the industry dedicated to the manufacturing of systems for the delivery and pick-up of packages, encompassing at the same time the area of video-entry phone systems and that of home automation.

### Background Art

As it is well known, the increase of online purchases has increased significantly the use of package delivery services, broadening the scope of their use from the traditional service that companies and commercial entities have been performing, to that of individual consumers. In any case, the main problem of this type of service comes from the need for, at the time of receiving or picking up a package, someone to be present in the home in order for the deliveryman to deliver or pick up the package in question, which is not always possible and greatly limits the users' freedom of movement.

To solve this problem, some services are made in specialized establishments with reception and pick-up lockers; however, as it deals with establishments that usually do not have personnel, they are exposed to acts of vandalism and, therefore, do not always ensure the integrity of the packages.

Furthermore, another of the disadvantages of this type of establishments is that the user is obliged to go to the site in which the service is found, both to pick up the packages and to deposit those he wants to return, where applicable, which also is a disadvantage, for example, for persons with problems of mobility.

The objective of this invention is, therefore, to develop a new locker system for receiving packages that avoids these disadvantages, allowing the user to receive the packages in a fully secure and reliable manner, without the need to move from his home but also being able to receive the packages at his home while he is in another place, for which a device has been developed that combines the use of lockers with the advantages that home automation provides, implementing it specifically in a video-entry phone that controls in the home and from a remote place the access to the building or living area and, therefore, access to the lockers.

Moreover, and with reference to the current state of the art, it can be stated that the existence of lockers or mailboxes is not known, at least by the applicant, where the deliverymen can deliver medium- and large-sized packages when the users are not at home, doing so with complete security and traceability of the fact that the package has been delivered correctly and securely. In particular, the existence is not known of any other device that presents equal or similar technical, structural and constituting characteristics to those that are claimed herein.

### BRIEF SUMMARY OF THE INVENTION

The invention, as the title of this descriptive report indicates, refers to a home automation device for package delivery and receipt that provides, when used as designed, advantages and characteristics that are described in detail below, which signify a novelty for the current state of the art.

More specifically, the purpose of the invention is focussed on a device designed for package delivery and receipt through an intelligent locker with electronically controlled opening and a home automation video-entry phone, whose objective is to facilitate the task of delivering and picking up shipments of packages or mail in users' homes and establishments, avoiding the need that they must encounter in the home for said pick-up and delivery, since the deliveryman, thanks to this device, can make the delivery of packages in the lockers with complete security and efficiency and can control this access of the deliveryman to the locker or of any other person to the property from the home or from any other remote site.

### BRIEF DESCRIPTION OF THE DRAWINGS

In order to complement the description that is being made and with the objective of aiding a better understanding of the invention's characteristics, a set of drawings accompany this descriptive report, as an integral part thereof, in which they include, but are not limited to the following:

FIG. 1. It shows a perspective view of a general representation of the device that is subject of the invention, noting the main elements that comprise it, that is, the smart locker and the video-entry phone.

FIG. 2. It shows a schematic view of the front of an example of the locker that makes up the device, according to the invention, noting the different receptacles that comprise it and the touch screen for accessing them.

FIG. 3. It shows a schematic view in perspective of the video-entry phone that comprises the device, according to the invention, showing the external terminal for accessing the building and the interior terminal in the home to which it is connected.

FIG. 4. It shows a perspective frontal view of the details of one of the receptacles of the locker represented with its door open, so that it shows schematically the elements that comprise the interior thereof.

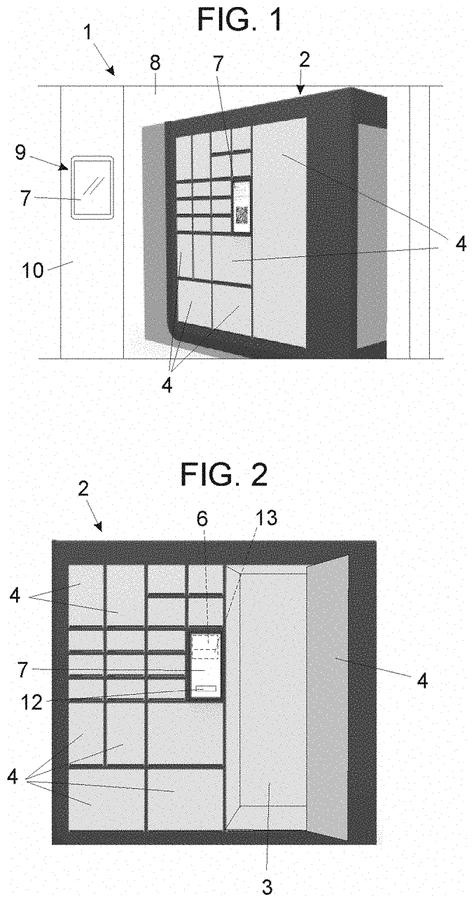

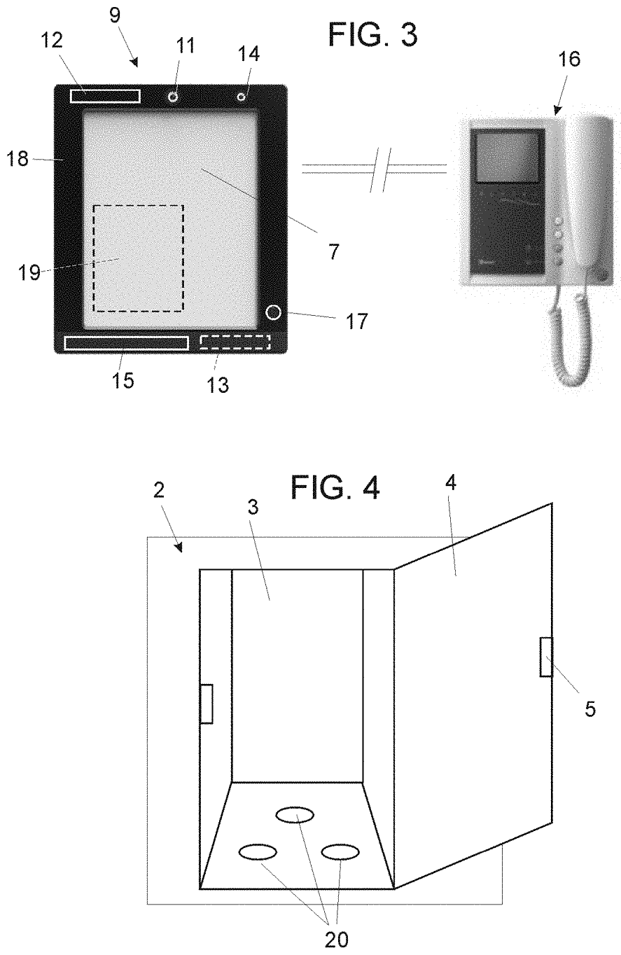

### DETAILED DESCRIPTION OF THE INVENTION

The home automation device for the delivery and receipt of packages that the invention proposes is configured, therefore, as a noteworthy novelty within its field of application, since according to its implementation and in an exhaustive manner the objectives indicated earlier are fulfilled satisfactorily, with the characterizing details of what makes it possible and that distinguish it being appropriately included in the final claims that accompany this description.

More specifically, what the invention proposes, as noted above, is a device that has the purpose of facilitating the delivery of packages, by the carriers or package deliverymen, for example of online sales, and of the users collecting said packages in their homes or establishments, avoiding the need for them to be at home for this, permitting the deliveryman to deliver one or more packages with total security and efficiency, and that the user can control his access to do this from the home itself or from any other remote site. This device consists, essentially, of two main elements:
at least, one smart locker with one or several receptacles, preferably of several different sizes, each one provided with a door with an opening by means of a lock electronically controlled through an electronic device with touch screen, QR code reader, Internet connection module and specific software that allows giving access to the personnel of the delivery company that has access to the locker, showing information of said company and, in addition, allows the user to access to this information through an application for an external electronic device, such as a smartphone or electronic tablet, with such locker being installed within an area, entrance or appropriate place in the property where the home of one or more users of the service is found;
and a home automation video-entry phone, which, appropriately installed in the external part of said property and equipped with the traditional components of camera, microphone, screen and buttons for calling and being able to give access to any person who calls through the complementary interior terminal or terminals or intercom situated within the home of the users, is also provided with at least one QR code reader, Internet connection module and specific software that allows giving access to the personnel of the delivery company who has access to the locker and that, in addition, allows the user to control remotely through an application for an external electronic device, such as a smartphone or electronic tablet.

More specifically, the video-entry phone has a touch screen and an operative system with Internet access, as well as two QR code readers (quick response code), so that the deliveryman of the transport agency, appropriately associated to the service, brings the QR code close that was assigned for the delivery of a package and he can in this way access the entry hall or interior of the building or property where the smart locker or lockers are found. The second QR code reader will serve for other package delivery companies or the post office.

In addition, the video-entry phone also has a camera and a microphone so that any user can communicate with the other terminal of the video-entry phone, that is, the intercom that is located in the interior of the home. the video-entry phone communicates, in turn, through an Internet connection and a specific application with the users' smartphones, in such a way that an owner of the property can answer the calls that he receives in his video-entry phone from his mobile telephone through the mobile application, even being able to open the door to the property from his smartphone.

The smart locker is formed by a set of receptacles of different sizes, each one with its door and it has a touch screen, electronically connected to the lock of each one of these doors, that in turn incorporates a QR code reader.

The touch screen also has an Internet connection, so that it allows access to information of a different type that the transport agency provides and, preferably, it informs the user on the state of his order and carries out the request for package shipments or correspondence, it also can show advertising.

On this screen, in addition, there is also a QR code reader to give access to the deliveryman from the package delivery company in order to be able to open the door of a certain receptacle of the locker, so that he may deposit in its interior the appropriate merchandise or pick up that which has been deposited there for its shipment. To do this, the deliverymen will receive the appropriate QR code in each case through a smart phone or digital tablet.

Furthermore, it is important to highlight that each one of the different receptacles or cubicles of the locker has, in its interior, a series of sensors appropriately connected to the electronics of the touch screen device, so that, when the deliveryman has placed the package inside the receptacle, these sensors confirm, once the door is closed, that the package is effectively inside the receptacle, sending this information to both the company and the user.

Through this service, the clients can receive and deliver any type of package and correspondence, from their home or through any distribution point in the network, since optionally, one or more additional lockers can be installed in different points separate from the users' properties or establishments, forming a package delivery and pick-up service network, in which case the video-entry phone that gives access to the local in which the locker is installed can be an optional element and, preferably, it will not have buttons, speaker or microphone for the traditional function of opening the door to the person calling, like a traditional video-entry phone system, but rather it will only be provided with the touch screen, camera and code reader to give access to the place in which the locker is installed.

In any case, for the functioning of the device of the invention, the creation is foreseen of a specific program and its functioning will be the following:
It will have a localizer indicator with the locker number and measurements, with a sensor for detecting whether or not there is a package in the locker.

The deliveryman will have to obtain a QR identifier number to be able to make the delivery and locate the locker with the necessary characteristics for the volume of the object and its availability. For the shipments, a transport company will pick up the object with the QR identifier number. If a multi-resident building is accessed, he will pass the QR identifier number through the reader of the touch video-entry phone and he will have access to the building where the lockers are located. He will end by passing the QR code through the reader of the screen located on the lockers. When the reader detects the code, it automatically opens the door to the locker. Once the object is placed inside the locker, the deliveryman closes the door, the sensor confirms the presence of the object in the locker and the smart design will transmit that its receipt is confirmed.

Then the user of the service, through his app, will receive a code in which he will have access by means of his mobile phone to the reader of the locker's screen and in this way obtain the object or package, considering the service finalized and leaving the locker available for the next services.

The video-entry phone is a model with a touch screen with camera, microphone and code reader. Its database will be based on the set of data pertaining to the context and stored systematically for subsequent use.

Preferably, the external parts that made up the video-entry phone are:
Ten-inch touch screen: manufactured with a new type of “ultra-resistant” panel, in addition to being “almost impossible to scratch”, for example, the model GORILLA GLASS 4, which deals with a thin transparent sheet manufactured from a combination of alkali-alumino-silicate that is used as a cover highly resistant to breakage and scratches in mobile or fixed devices with a touch screen, not ruling out also putting a protective sheet that keeps the glass free of abrasion without reducing the screen's touch sensitivity. Resistant to external agents, such as water and dust.
Camera: It allows the user to visualize the person who wants to access the building. Security system for taping with a data storage system.
QR code reader: One or two readers. At least a primary reader for access by the deliverymen from the transport agencies. and optionally, a second reader, for other companies, such as the Post Office, who want to use it for the delivery of ordinary mail, which is another advantage of the device.
Microphone: Optionally with changeable volume, if necessary.
ON/OFF button: Allows activating the equipment, preferably configured with a suspension timer for energy savings.
Cover: Protects the internal circuits of the device and gives it presentation, respectively.

The video-entry phone gets electrical power through an internal battery that is charged by the same network when it needs to be powered. In this way, in case of power outages, it will continue working without any type of problems.

Finally, it should be indicated regarding the video-entry phone application device: In relation to the user of the home, no type of key is necessary to access his home, (although there should be a key in case any type of problem might arise) since by simply pressing a code one can access the building. This code could be entered from the video-entry phone or from the mobile, serving in turn as a remote intercom when answering calls of visits to the home, because through the mobile one can also see that the camera of video-entry phone registers and gives access to the person who at that time is asking to enter the building.

Unless otherwise indicated, all the technical and scientific elements described in this report have the meaning that is usually understood by a normal expert in the field to which this invention pertains. In the practice of the invention, one can use procedures and materials that are similar or equivalent to those described.

The described home automation device for the delivery and receipt of packages represents, therefore, an innovation of structural and constitutive characteristics unknown up to now, reasons for which along with its practical utility, give it sufficient basis for obtaining the privilege of exclusivity that is requested.

### DESCRIPTION OF THE PREFERRED EMBODIMENT

In view of the mentioned figures, and in accordance with the numeration adopted, a non-limited example of the device of the invention, which includes the parts and elements that are indicated and described in detail below.

Therefore, as observed in this FIG. 1, the device (1) in question is comprised, essentially, by:
at least one smart locker (2) with one or several receptacles (3), each one provided with a door (4) with a lock (5) with automatic opening controlled through an electronic board (6) linked to a touch screen (7) on each locker (2), which is installed within the building (8), entrance hall or location on the property of the home of one or more users of the service, as shown in FIG. 1, or else in a separate location;
and a home automation video-entry phone (9) that, installed externally to said building (8) or location, next to the entrance (10) connected to its lock, equipped with at least a video camera (11), a touch screen (7), a QR code reader (12), Internet connection module (13) and a programmable operating system with specific software to give access to this entrance (10) using the QR code that the reader detects, to allow the personnel of the delivery company to have access to the locker (2), and in order to be linked to a mobile phone application, which allows the users to remotely control it through an external electronic device, such as a smart phone or an electronic tablet.

Especially when the locker (2) is installed in a building (8) of a property of users, the video-entry phone (9) preferably also incorporates a microphone (14), speaker (15), button panel, preferably through the touch screen (7), to serve as the traditional video-entry phone and allow access to this property to whoever calls, by means of a terminal or complementary intercom (16) situated within the home of the users, also allowing the use of the mobile application to use it as a substitute of the intercom (16) from a remote location.

Preferably, the smart locker (2) has various receptacles (3) of different sizes.

Preferably, the electronics (6) of the locker's (2) touch screen (7) also incorporates a QR code reader (12), an Internet connection module (13) and specific programmable software in order to open the door (4) of one or another of the different receptacles (3) according to the QR code that the reader detects, in order to show information through the touch screen (7) and to be linked with a mobile application, that allows the users to connect to it through an external electronic device, such as a smart phone or an electronic tablet.

Preferably, each receptacle (3) of the smart locker (2) incorporates inside it one or several sensors (20) that detect the merchandise, which are connected to the electronics (6) of the locker's (2) touch screen (7).

Optionally, the video-entry phone (9) has two QR code readers (12) that read different types of QR codes from different service companies.

Preferably, the video-entry phone (9) has an ON/OFF button (17) to activate the equipment, preferably configured with a suspension timer, to save energy, with a protective casing (18) that protects its internal circuits from possible vandalism and a battery (19) of electrical power, optionally connected to the network, to be supplied when needed.

Having described sufficiently the nature of this invention, as well as the way to put it into practice, it is not considered necessary to extend further its explanation so that any expert in the subject may understand its scope and the advantages that are derived from it, placing on the record that, within its essence, it could be put into practice in other forms of realization that differ in detail from that indicated as an example, and that will also be under the protection that is obtained as long as it does not alter, change or modify its basic principle.

1. Home automation device for package delivery and receipt comprising:
at least one smart locker with one or several receptacles, each one provided with a door with a lock with automatic opening controlled through an electronic board linked to a touch screen on each locker, which is installed within the building, entrance hall or location on the property of the home of one or more users of the service, or else in a separate location;
a home automation video-entry phone installed externally to said building or location, next to the entrance connected to its lock, equipped with
at least a video camera,
a touch screen,
a QR code reader,
an internet connection module and
a programmable operating system with specific software to give access to this entrance using the QR code that the reader detects, in order to be linked to a mobile phone application.

2. The device according to claim 1, characterized in that the video-entry phone, especially when the locker is installed in a building of a property of users, it also incorporates a microphone, speaker, button panel, to serve as the traditional video-entry phone by means of a terminal or complementary intercom and through the mobile application.

3. The device according to claim 1, characterized in that the smart locker has various receptacles of different sizes.

4. The device according to claim 3, characterized in that the electronics of the locker's touch screen also incorporates a QR code reader, an Internet connection module and specific programmable software in order to open the door of one or another of the different receptacles according to the QR code that the reader detects, in order to show information through the touch screen and to be linked with a mobile application.

5. The device according to claim 4, characterized in that each receptacle of the smart locker incorporates inside one or several sensors that detect the merchandise, which are connected to the electronics of the locker's touch screen.

6. The device according to claim 5, characterized in that the video-entry phone has two QR code readers that read different types of QR codes.

7. The device according to claim 6, characterized in that the video-entry phone has an ON/OFF button to activate the equipment.

8. The device according to claim 7, characterized in that the video-entry phone has a vandalism proof protective casing.

9. The device according to claim 8, characterized in that the video-entry phone has a battery of electrical power.
